(19) United States
(12) Patent Application Publication
(10) Pub. No.: US 2004/0017285 A1
(43) Pub. Date: Jan. 29, 2004

(54) Computer controlled positioning device

(76) Inventors: Reuben Q. Zielinski, Belle Mead, NJ (US); Monte R. Zielinski, Madisonville, TN (US); Jason H. Zielinski, Fredonia, NY (US)

Correspondence Address: Eric A. Dichter, Wolf, Block, Schorr and Solis-Cohen LLP, 1650 Arch Street, Philadelphia, PA, 19103, US

(21) Appl. No.: 10/628,972

(22) Filed: Jul. 28, 2003

Related U.S. Application Data
(60) Provisional application No. 60/398,738, filed on Jul. 26, 2002.

(51) Int. Cl. G08B 21/00

(52) U.S. Cl. 340/431

(57) ABSTRACT

A computer controlled positioning device detects the relative position of a towing vehicle and item being towed based on the feedback signal of a 5th wheel encoder affixed to the attachment point on the towing vehicle and in contact with the towed item. The signal is produced based on the rotation of a wheel on the 5th wheel encoder in response to the angular change between the towing vehicle and item being towed at the pivot (attachment) point as the towing vehicle turns, corners, or reverses. The signal is transmitted to a microprocessor under software control that determines if the rearview mirror(s) should be rotated and/or if a notification should be provided to a driver.

### CROSS-REFERENCE TO RELATED APPLICATION

This application claims the benefit of U.S. Provisional Application No. 60/398,738, filed Jul. 26, 2002, the entire disclosure of which is incorporated herein by reference.

### FIELD OF THE INVENTION

This invention relates generally to the detection of the relative positioning of towing vehicles and the vehicles or objects that are being towed, such as tractor-trailer combinations. More particularly, the invention relates to a device that automatically rotates the rearview mirrors or alerts the driver in response to the angular positional relationship between a towing vehicle and item being towed by the vehicle.

### BACKGROUND OF THE INVENTION

It is common practice to align externally mounted rear-view mirrors in such a manner so as to permit a driver's line of sight to include the rear end of the trailer. This line of sight (so called “reflective line of sight”) is possible only when a tractor-trailer, towed recreational camper/boat, and the like are aligned straight on a common central axis. When a right hand turn is negotiated, a conventional right hand mirror reflects a line of sight that is forward of the rear of the trailer and the left hand mirror is directed outwardly away from the trailer and of little use.

Similarly, a negotiated left hand turn would leave a conventional left hand mirror reflecting a line of sight that is forward of the left rear of the trailer and the right hand mirror is directed outwardly away from the trailer. In both cases, the rear of the trailer would not be visible to the driver and only a portion of one side would be visible.

Some convex mirrors mounted together with the rear-view mirrors allow the viewing of the rear end of the trailer during turns; however, these produce the unwanted side effect of the loss of depth perception.

Motorized mirrors exist that are actuated by a toggle switch in the cab that permits the driver to rotate the right hand rear-view mirror. However, this system is dependent on an estimated reflected line of sight and requires the driver to actuate the mirror control and remove one hand off the steering wheel while turning. In addition, other existing motorized mirrors have an unacceptable response time when the rotation of the mirror is desired, and thus, cannot be used for automatic real-time adjustments.

Furthermore, existing mirrors and towing systems do not provide for sensing of the positioning of the towing vehicle and towed item and notification of their relative positioning, such as where they are likelihood to cause damage.

Thus, there is a need for a device for detecting the relative positioning of towing vehicles and towed items and automatically alert the driver and/or actuate rearview mirrors in response to the positioning in real time without the need for manual intervention.

### SUMMARY OF THE INVENTION

The present invention achieves the above-mentioned goals by providing a positioning apparatus that detects the relative angular position of a towing vehicle and towed item and generates a signal that actuates one or more rearview mirrors on the towing vehicle and/or provides notification, for example, an audible or visible alert to the driver, of the relative angular position.

The positioning apparatus of the present invention comprises a microprocessor-controlled 5th wheel encoder (“F.W.E.”) that detects the relative positioning of a towing vehicle and item being towed. The positioning information is linked with a rearview mirror actuating device and notification device to control the position of the rearview mirror(s) and/or provide notification to the driver.

The apparatus of the present invention comprises an optically encoded feedback signal based on the attachment (or pivot) point between a towing vehicle and towed vehicle/object. The signal is provided to a microprocessor that processes the information from the signal into control of the position of motorized rearview mirrors and/or notification of the relative positioning of the towing vehicle and towed vehicle/object. The relative positioning is calculated from the angular displacement of the towed vehicle/object with respect to the towing vehicle derived from the rotation of a sensing wheel on the 5th wheel encoder. The sensing wheel is in contact with the towed item and rotates as the towing vehicle corners or backs up at a specific angle.

The sensing wheel may be controlled by an air spring, a conventional spring, or a solenoid, among other suitable devices. These and other details and advantages are discussed in the following detailed description of the present invention.

### BRIEF DESCRIPTION OF THE DRAWINGS

FIG. 1 is an overhead view of the 5th wheel encoder mechanism attached to a trailer in the present invention.

FIG. 2 is a side view of the 5th wheel encoder mechanism.

FIG. 3A is a side view of the 5th wheel encoder mechanism showing operation of the device.

FIG. 3B is a side view of the 5th wheel encoder mechanism showing operation of the device.

FIG. 4 is a depiction of the microprocessor used in the present invention.

FIG. 5 is a side view of the 5th wheel encoder mechanism of the present invention.

FIG. 6 is a side view of the 5th wheel encoder mechanism of the present invention attached to a tractor.

FIG. 7 is a side view of the 5th wheel encoder mechanism of the present invention attached to a tractor and coupled to a trailer.

FIG. 8 is a side view of the 5th wheel encoder mechanism of the present invention attached to a tractor and coupled to a trailer via kingpin attachment.

FIG. 9 is a top view of the 5th wheel encoder mechanism of the present invention attached to a tractor and coupled to a trailer.

FIG. 10 is a top view of the present invention used with pickup trucks and SUV's.

FIG. 11A is a top view of the 5th wheel encoder used with pickup trucks and SUV's.

FIG. 11B is a side view of the 5th wheel encoder used with pickup trucks and SUV's.

FIG. 12A is a side view of a trailer hitch used with pickup trucks and SUV's for the present invention.

FIG. 12B is a side view of a ball hitch used with pickup trucks and SUV's for the present invention.

FIG. 13 is a side view of a trailer hitch attached to the receiver of the pickup truck or SUV for the present invention.

FIG. 14 is a top view of the 5th wheel encoder mechanism used with pickup trucks and SUV's coupled to a trailer.

FIG. 15 is a side view of the 5th wheel encoder mechanism of the present invention attached to a tractor and coupled to a trailer.

FIG. 16 is a side view of the 5th wheel encoder mechanism of the present invention attached to a tractor and coupled to a trailer.

FIG. 17 is a perspective view of a first embodiment of mounting hardware for the 5th wheel encoder mechanism of the present invention.

FIG. 18 is a side view of the first embodiment of mounting hardware for the 5th wheel encoder mechanism of the present invention.

FIG. 19 is a perspective view of a second embodiment of mounting hardware for the 5th wheel encoder mechanism of the present invention.

FIG. 20 is a top view of a strike plate and trailer hitch used with pickup trucks and SUV's for the present invention.

FIG. 21 is a flow chart showing the steps of the software used in the present invention.

FIG. 22 is a flow chart showing the steps of the software used in the present invention.

FIG. 23 is a flow chart showing the steps of the software used in the present invention.

FIG. 24 is a flow chart showing the steps of the software used in the present invention.

### DETAILED DESCRIPTION OF THE PREFERRED EMBODIMENTS

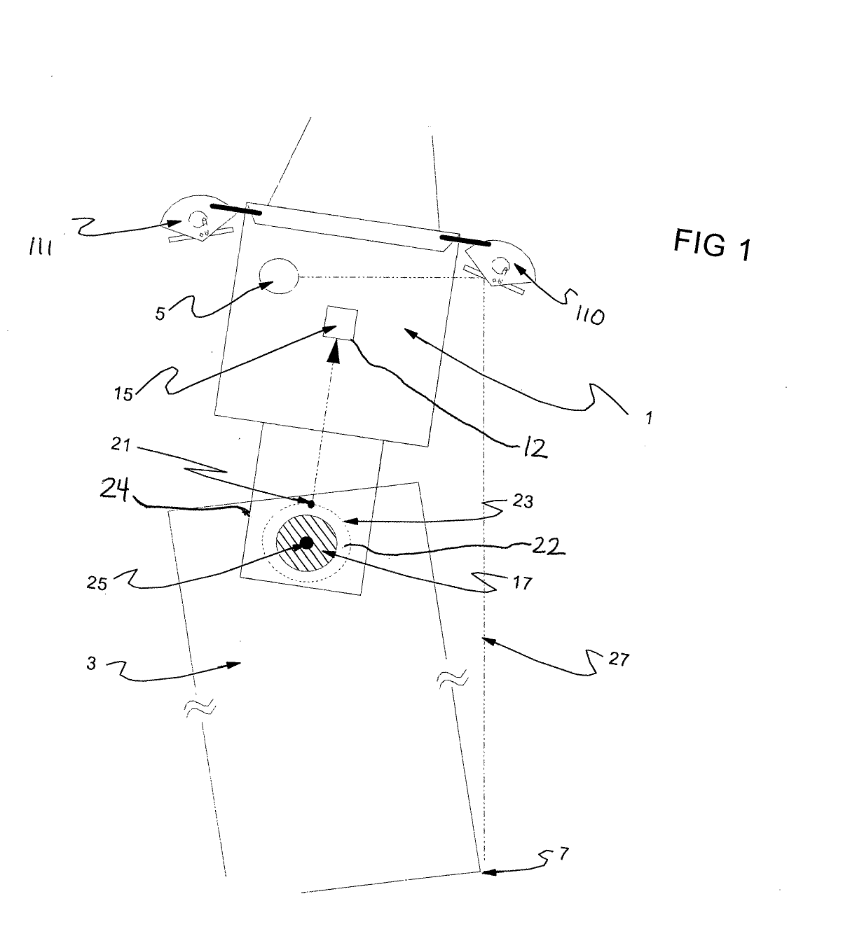

In one embodiment of the present invention used for rearview mirror positioning, referring to FIG. 1, a tractor (towing vehicle) 1 is attached to a trailer (towed vehicle) 3 at an attachment point 25 by known king-pin attachment means 24. Any other suitable attachment mechanisms preserving the pivoting feature of the tractor 1 and trailer 3 can be used.

The present invention allows the mirror position to be controlled so that, at the angle shown, driver 5 can view the right-hand rear of the trailer 7 along the reflected line of sight 27 using the right-hand mirror 110. A similar description would be applicable to the left-hand mirror 111 if the tractor 1 was angled to the left. It will be generally understood that a simultaneous or complementary actuation of the left-hand mirror along with the right-hand mirror is also considered in the scope of this invention.

The trailer 3 rests on what is known as the “fifth-wheel” plate 17 that is integral to and attached to the tractor 1. The fifth-wheel plate 17, a variation thereof, or other attachment point is commonly found on all vehicles that are capable of towing items; this serves as the attachment point of trailers or other items being towed. The trailer pivots about an axis at attachment point 25 (on the fifth-wheel plate 17) with respect to the tractor 1.

As the angular displacement between the tractor 1 and the trailer 3 changes, a sensing wheel 22 of the 5th wheel encoder 21 rotates in a circular path 23 which is concentric about the pivot point 25. The 5th wheel encoder 21, as used herein, is a device that is attached to the fifth-wheel plate 17 or other attachment mechanism of a towing vehicle; the 5th wheel encoder 21 senses the relative angular positioning of the tractor 1 and trailer 3. It provides a linear signal, optionally through an optical encoder and decoder, to the microprocessor 12 in the computer box 15 which controls the movement of mirrors 110 and 111. In one embodiment, the mirrors 110 and 111 are controlled by an electronic, geared stepper motor; however, any suitable mechanism that changes the angles of the mirrors 110 and 111 can be used. The microprocessor 12 also controls the notification of the relative positioning.

For purposes of the present invention, the 5th wheel encoder 21 is not limited to use with the fifth-wheel plate 17. In contrast, the 5th wheel encoder 21 can be used with any mechanism for attaching a towed item to a towing vehicle. The 5th wheel encoder 21 may rest vertically, horizontally, diagonally, or in any other alignment that enables it to be in contact with the attachment point 25 and sense the relative angle between the tractor 1 and trailer 3.

Generally, the bottom portion of the trailer 3 rests tangentially to the sensing wheel 22 of the 5th wheel encoder 21. When the tractor 1 angles toward the right, such as during a right turn, the sensing wheel 22 rotates in the clockwise direction. Conversely, when the tractor 1 angles toward the left, such as during a left turn, the sensing wheel 22 rotates in the counterclockwise direction. The amount of rotation of the sensing wheel 22 is dictated by the angular positioning change between the tractor 1 and trailer 3.

The amount of rotation of the sensing wheel 22 is detected by the microprocessor 12; it correlates the amount of rotation with the movement of one or both rearview mirrors 110 and 111. This correlation can be performed through a mathematical equation using various constants depending on variables for the tractor 1 and trailer 3. These variables include, without limitation, the length and width of the trailer, the weight of the trailer, the trailer's axle width, the position of the 5th wheel encoder 21, the position of the fifth wheel plate 17 on the tractor 1, and the position of the trailer axes.

For example, the regulations of the Department of Transportation govern the maximum weight on each axle of a tractor-trailer combination. According to the present invention, the fifth wheel plate 17 is adjustable in that it can slide and be locked in any position within approximately 48 inches (″) of adjustment. This permits the driver to distribute the weight of the loaded trailer so as to comply with the weight/axle regulations. Similarly, the position of the axles can be adjusted to comply with weight distribution requirements. Weight distribution can be detected at weigh stations by load cells under each axle. Failure to comply with these regulations can result in fines levied on the driver or trucking company. Thus, as these variables and the weight distributions change, the correlation (e.g., constants used in mathematical equations) between angular positioning detected by the 5th wheel encoder is adjusted.

Many or all of the tractor, trailer, and hitch variables can be detected by the 5th wheel encoder 21, such as through use of a load cell or an accelerometer to measure shock and vibration. This can be done for shipping insurance purposes, and/or to trigger the logging of angular displacement for traffic accident recreation routines.

The 5th wheel encoder 21 operates via a conventional spring, an air spring, or a solenoid, among other suitable compressible mechanisms. When the trailer 3 rests upon the tractor 1, the spring 16, having a suitable length and spring constant, compresses. The compression of the spring 16 adjusts based on the relative positioning of the tractor 1 and trailer 3; however, a constant force is maintained from the 5th wheel encoder 21 to the trailer 3.

Similarly, with an air spring 16 (shown in FIGS. 15 and 16), a pressure regulator provides constant pressure to the air spring and the air spring compresses and expands based on the relative positioning of the tractor 1 and trailer 3. Furthermore, with a solenoid, a constant electromagnetic force is applied to hold the 5th wheel encoder 21 against the bottom of the trailer 3. The solenoid actuates (changes positions) similar to a spring based on the relative positioning of the tractor 1 and trailer 3.

A 16-bit divide can be used within mathematical equations to resolve the ratio between rotation of the sensing wheel 22 and movement of the rearview mirrors 110 and 111. Alternatively, there can be a lookup table of proper stored ratios accessed by the microprocessor 12 that can convert rotation into movement. In any case, the present invention provides for manual override to determine the ratio based on the above variables.

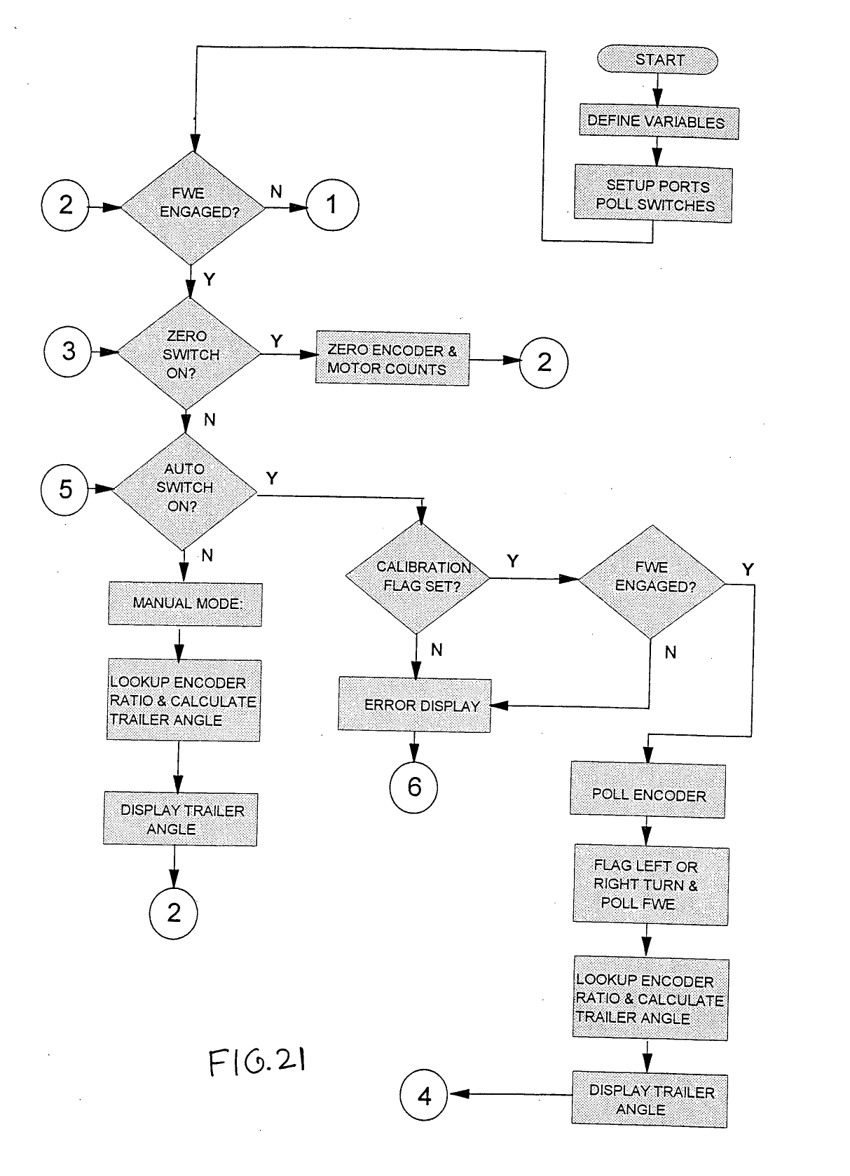

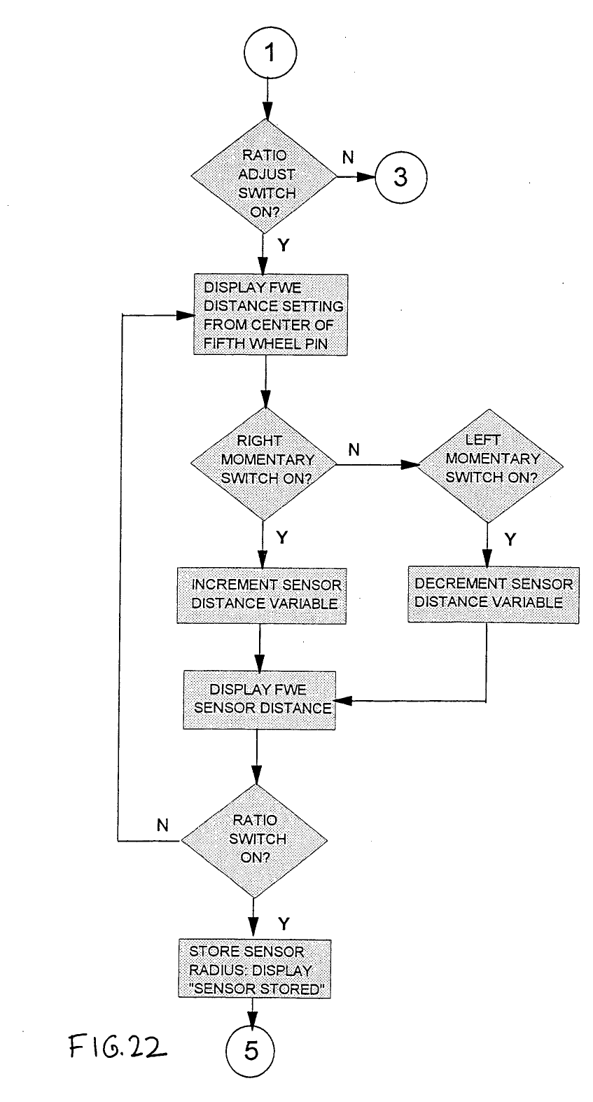

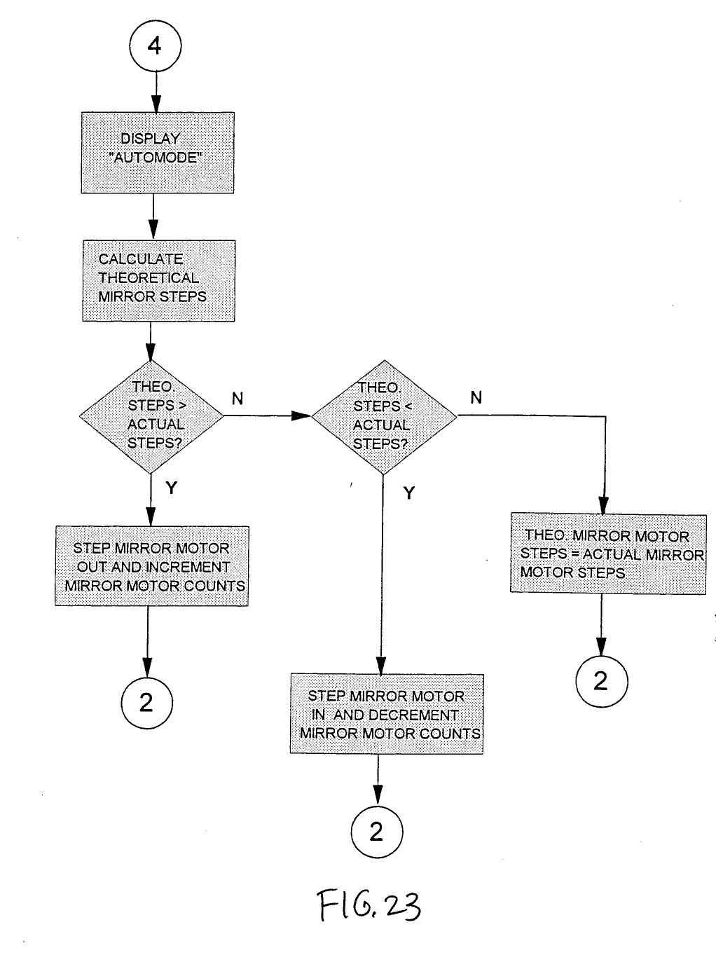

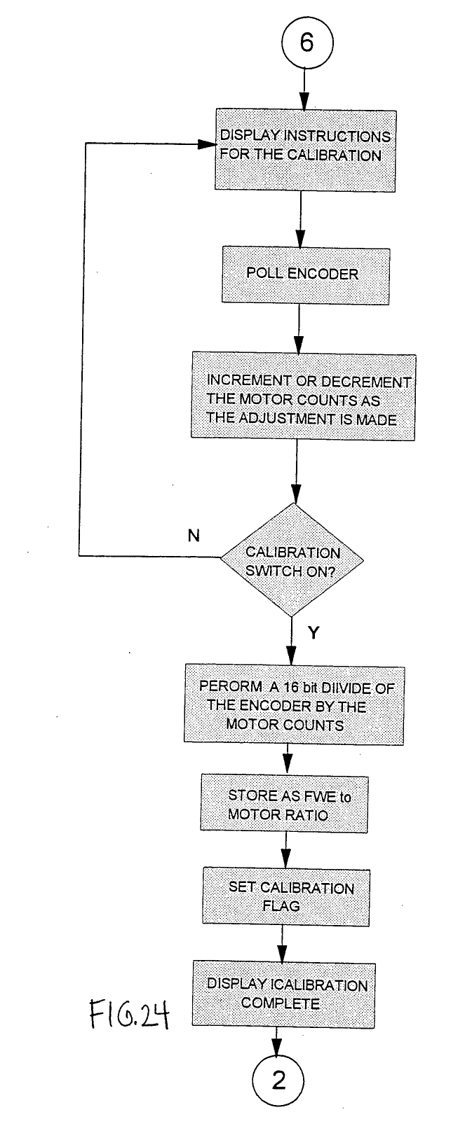

The microprocessor 12 contains software that calculates the proper movement of the mirrors and transmits this information to the mirror motor for actuation of the mirrors. The software may be embedded in the microprocessor 12 or be contained on a non-permanent storage device, such as flash memory, or any other suitable software control mechanism. The software may be reprogrammable to allow variation in positioning constants and other factors. In one embodiment, the microprocessor 12 may be in communication with a computer network, for example, via a wireless connection, that will allow reprogramming from the driver's seat, a remote location, etc. FIGS. 21-24 show the steps and routine of the software used in the present invention.

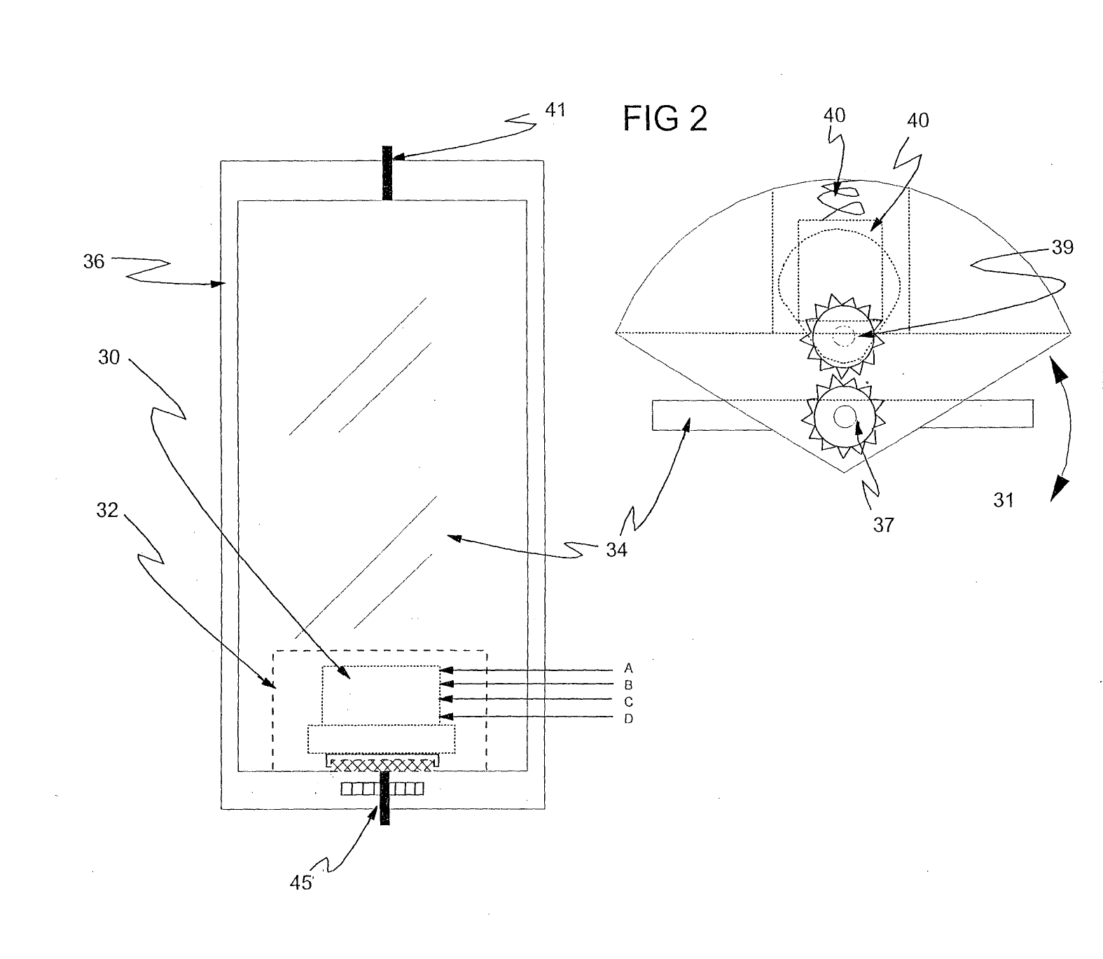

Referring to FIG. 2, an enlarged and more detailed view of the moveable mirror configuration is shown. The geared stepper motor 30 is enclosed in a suitable weather-tight enclosure 32 with the mirror 34 attached via pivot points 41 and 45 to enclosure (or vehicle) 36. The mirror 34 is mechanically actuated by the geared stepper motor 30 through gears 37 and 39, at least one of which is permanently attached to mirror 34.

Geared stepper motor 30 and attached gear 37 are mounted on slide 40. Spring 44 is used to maintain force on slide 40 and thus provides the requisite force between mating gears 37 and 39. Movement of geared stepper motor 30 and mirror 34 are provided by Direct Current (DC) electrical stimulus fed via winding phases A, B, C, and D. Winding phases A, B, C, and D are energized and de-energized under microprocessor program control. This in turn causes geared stepper motor 30 to step in known angular displacement increments.

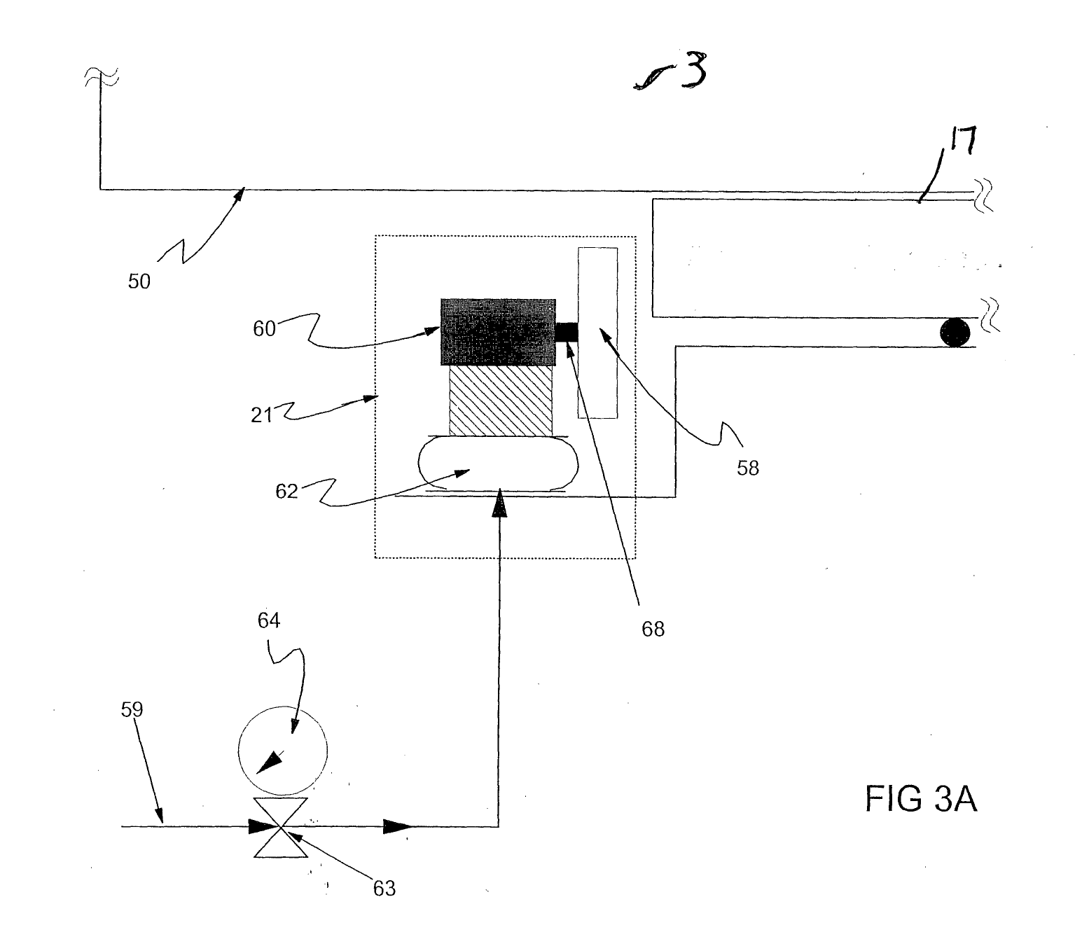

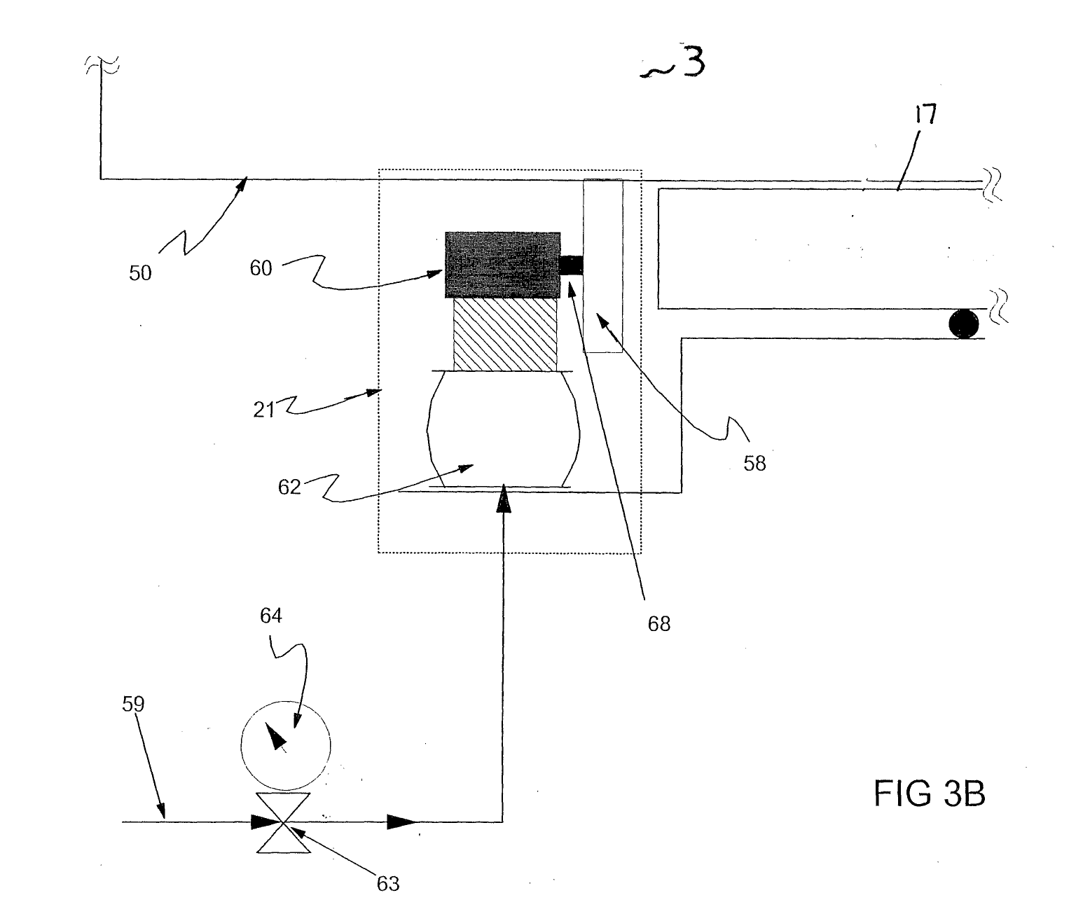

As best shown in FIG. 3A, the front end of the trailer undercarriage 50 is resting on “fifth-wheel” plate 17 with the 5th wheel encoder 21 providing means of coupling between the fifth wheel plate 17 and trailer undercarriage. The 5th wheel encoder 21 is comprised of a suitable weathertight enclosure containing an optical encoder 60, as known in the relevant art, which is rotated by a shaft 68 that is coupled to an actuating wheel 58. The actuating wheel 58 has a suitable interface (machined or elastomeric) about its edge to reduce slippage when contacting said trailer undercarriage 50.

The encoder wheel interface 21 is attached to a suitable truck mounting frame through pneumatically actuated airspring 62. Pneumatically actuated airspring 62 is shown connected to truck pneumatic system 59 with pressure regulator 63 regulating air pressure to airspring 62. Pressure gauge 64 shows zero pneumatic pressure on pneumatic line 65 and thus airspring 62, being comprised of known impregnated butyl rubber which is both rigid and compliant is deflated. The mechanism of airspring 62 can be substituted by a conventional spring or solenoid and maintain proper function.

As best shown in FIG. 3B, pneumatically actuated airspring 62 is connected to truck pneumatic system 59 with electro-pneumatic valve 63 and regulating air pressure regulator 64 to airspring 62. Electro-pneumatic valve 63 is under microprocessor control via electrical signal E. Pressure regulator 64 is shown with some level of air pressure, determined by airspring 62 specifications, to cause elongation of airspring 62 and thus making tangential contact with trailer undercarriage 50.

It can now be understood that when electrical signal E is energized and de-energized, electro-pneumatic valve 63 permits compressed air pressure to be applied to pressure regulator 63 and then removed, the expansion and contraction of airspring 62 permits contact and retraction of the 5th wheel encoder 21 to facilitate trailer coupling/decoupling.

In the embodiment shown, the “fifth-wheel” plate 17 is a fixed and permanent part of the trailer and describes a concentric circular path about the trailer undercarriage 50 as the relative angular displacement between the tractor 1 and trailer 3 changes. As this angular displacement occurs, the actuating wheel 58 rotates by virtue of the frictional force between the actuating wheel 58 and the trailer undercarriage 50 that rotates optical encoder 60.

A suitable optical encoder 60 is powered by a suitable DC voltage F and produces two signals G and H which contain directional and rotational pivot point information. This information is resolved through a mathematical equation based on the information being proportional to the changing angular displacement.

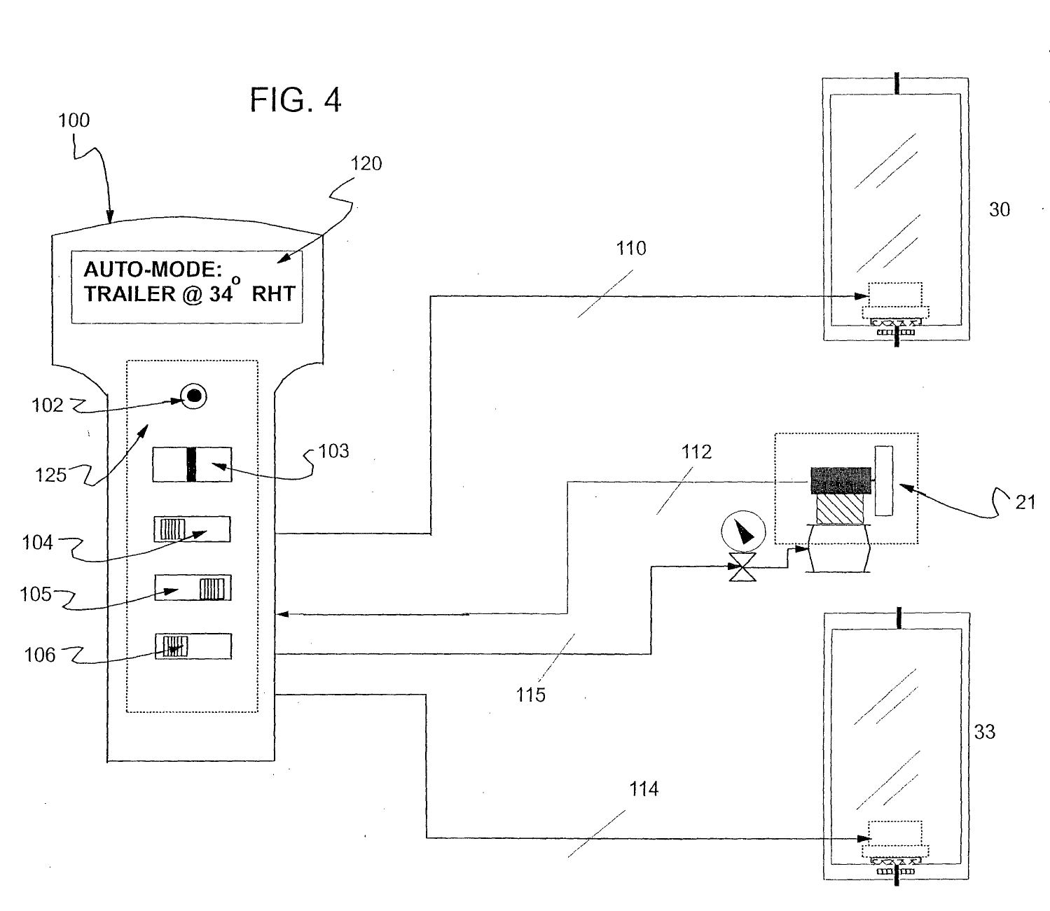

Referring now to FIG. 4, the microprocessor controller 100 is shown with LCD display 120, user interface keys 102, 103, 104, 105, and 106. Microprocessor controller 100 uses control algorithms residing in on-board Read-Only Memory (ROM). Alternatively, the algorithms may be used in software stored in the controller 100 or connected to the controller via any suitable electronic storage device.

The microprocessor controller 100 is connected to geared stepper motors 30 and 33 through open-collector Darlington transistors suitable to energize phased winding busses 110 and 114. Other transistors compatible with various microprocessors can also be used. Controller 100 controls geared stepper motors 30 and 33 movement via driver lines 110 and 114 under software control which provide the exact position via step counters in assigned microprocessor registers. The 5th wheel encoder 21, as described above, outputs signal lines 112 by means of attached optical encoder 60 and are decoded into directional and rotational information by microprocessor controller 100 under software control.

Software polled reset button 102 provides means to reset the system under automatic or manual control. Software polled rocker switch 103 provides means for rotating the mirrors outwardly or inwardly under manual control, inputting trailer length, and other specific control functions or variables to impact the calculation of relative positioning from the angle detected by the 5th wheel encoder. For example, if the user changes the length of the trailer being towed and inputs this information into the microprocessor controller 100, it will adjust the equation (or algorithm) for calculating the relative positioning of the trailer and towing vehicle. The new equation will account for the change in trailer length and a mirror will be actuated differently (than for the previous length trailer) in order for the driver to view the rear of the trailer while turning.

Software polled switch 104 is used to select the driver side or passenger side mirror for manual rotation, while switch 105 is used to select the system in the manual or automatic mode. Switch 106 is used to engage or disengage the 5th wheel encoder 21. Display 120 and switch matrix 125 are used as the interface into the control algorithms for the mirror system, and are generally understood to be tailorable and flexible, so any system information can be displayed and any keys from the keypad 125 can be assigned specific control functions.

The system discussed above operates, in general, to provide automatic alignment means on the rear-view mirrors 30 and 33. The operator selects a 5th wheel encoder mounting radius using rocker switch 103 on switch matrix 125 and increases or decreases the displayed mounting radius using visual feedback information from display 120. This increment or decrement of mounting radius translates into the changing of a constant within the control algorithms in the form of a look-up table, which is used to set a ratio of the encoder interface 21 counts to the angular displacement of the trailer with respect to the truck. Another user selectable variable is the trailer length which is stored in a look-up table. These constants thus govern the precise rotation of the geared stepper motor 30 and, thus, the line of sight of mirror 34.

It can now be understood that this information is used by the microprocessor controller to move the mirrors 30 and 33 in a real-time, automatic fashion, governed by the feedback signal from the 5th wheel encoder 21 and proportionality constant selected by the operator.

In general, the microprocessor 100 samples the 5th wheel encoder through encoder signals 112 which are in quadrature and are used to calculate rotational direction and angular displacement. When microprocessor 100 detects any deviation of counts on 5th wheel encoder 21 due to trailer rotation about “fifth-wheel” plate which would signify a turn, microprocessor selects the appropriate mirror and outputs the proper rotational information based upon the multiplication of an operator selected constant.

The geared stepper-motor 30 is repeatedly stepped on and off to provide mirror rotation and precisely equals that of the multiplied constant. In this manner, the mirror system is held in closed-loop feedback control and the operator maintains a line-of-sight on the rear-end of the trailer.

The system can further be programmed to collect angular velocity data of the truck with respect to the trailer, and signature analysis routines used to alarm the driver of various conditions. For example, angular displacement and velocity measurements can be used to determine driver drowsiness and provide wake-up alarms, with sensitivity levels that are user selectable. Accident recreation routines can be implemented to precisely log and save in the system the angular displacements up until a truck or other automobile is involved in a traffic accident. This is especially applicable to truck jack-knife conditions or back-up collisions. This could facilitate faster accident fault determination, speeding insurance claims and reducing lawsuits.

Microcontroller senses Right Turn Signal or Left Turn Signal vis-à-vis direct circuit or toroidal clamps. This sensing permits the control code to swing (modulate) either driver mirror or passenger mirror back and forth for purposes of examining the “blind spot” prior to a lane change. Once the signals stopped through driver intervention, the mirrors would automatically be positioned per the 5th wheel encoder position. The modulation of the mirrors is in real time and governed within the control code as the mirrors track based on the 5th wheel encoder proportionality constant calculated.

In additional embodiments, the computer controlled positioning device can be used with pickup trucks, sport utility vehicles, and other automobiles using standard ball and hitch or any other towing mechanisms. The invention can be used for mirror positioning control, notification of the position of the towed item in relation to the vehicle, or both. Also, the present invention can be used with heavy trailers using pintle hitch (I hooks) for attachment of towed items.

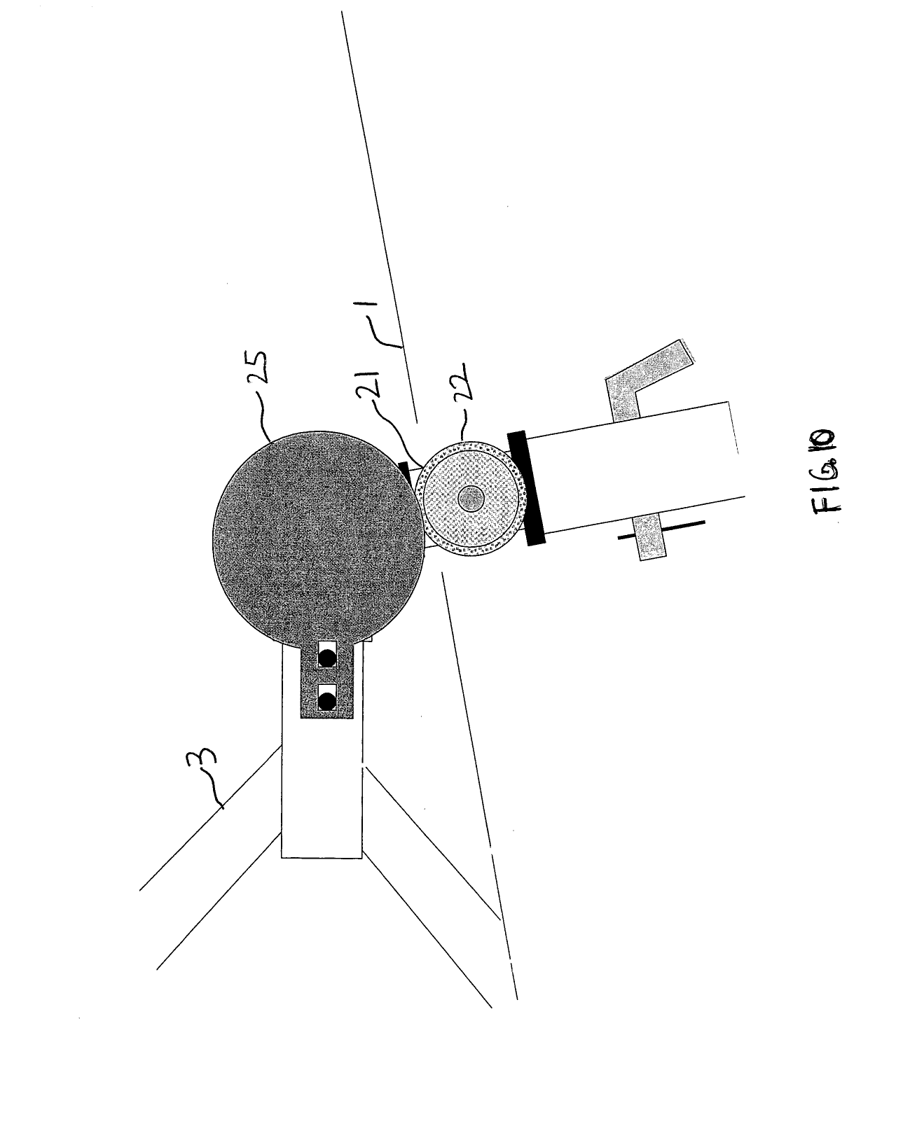

In one embodiment of the invention generally used with pickup trucks and SUV's used to tow items, as shown in FIGS. 10-14, the system detects the angle between the hitch on the towing vehicle and the item being towed. The microprocessor controller is programmed with the maximum angle that can be tolerated before there is a risk that the towed item 3 will damage the towing vehicle 1. This may be referred to as the “pinch-point.” The 5th wheel encoder 21 detects the angle as described above with reference to other embodiments and transmits this information via the optical encoder or any other transmission mechanism to the microprocessor controller.

When the angle limit is reached, a notification, such as an audible alarm, is provided to try to avoid any cosmetic or more serious structural damage to the towing vehicle's bumper, the hitch, and/or the towed item. In addition to the notification, the system of the present invention may provide a safety mechanism that engages to protect the parts of the towing vehicle and/or towed vehicle when notification is provided. This can be done automatically by the system or operated manually by an occupant (e.g., driver) of the towing vehicle. The alarm may be similar in nature to the ultrasonic detector used with some automobiles. This detector sounds an alarm when an object (e.g., a bicycle, person, another automobile, wall, etc.) is detected close to the rear of the automobile as it reverses. The sensor of the present invention can be set to sound an alarm when an object 3 (trailer) is within a specific distance from the tractor 1 (e.g., six feet).

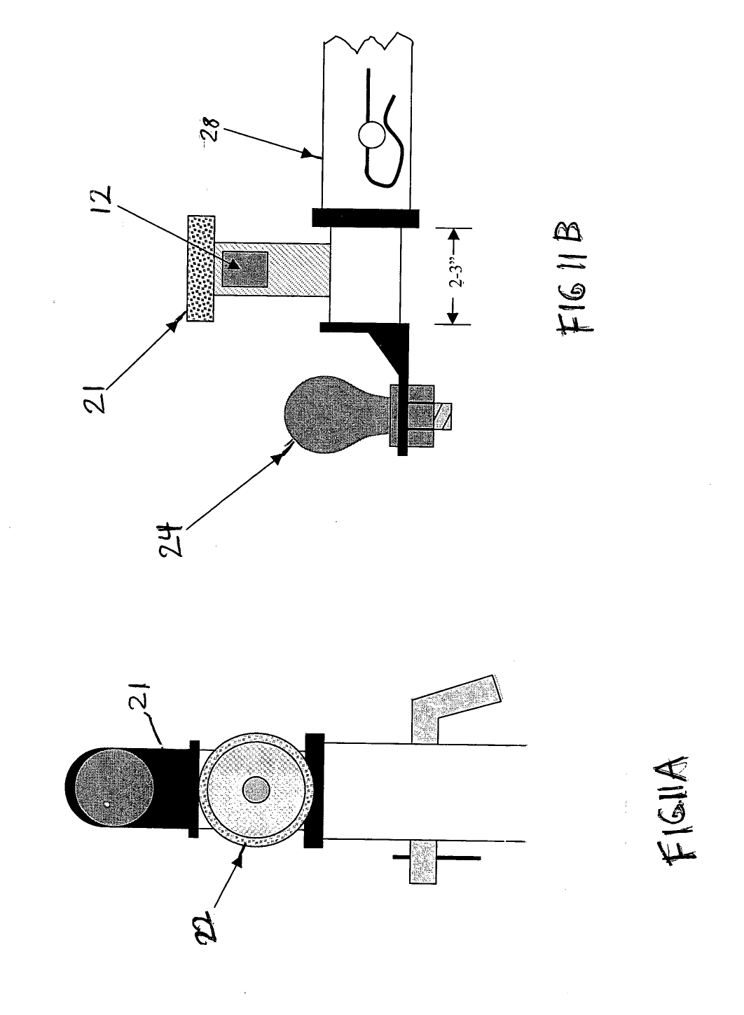

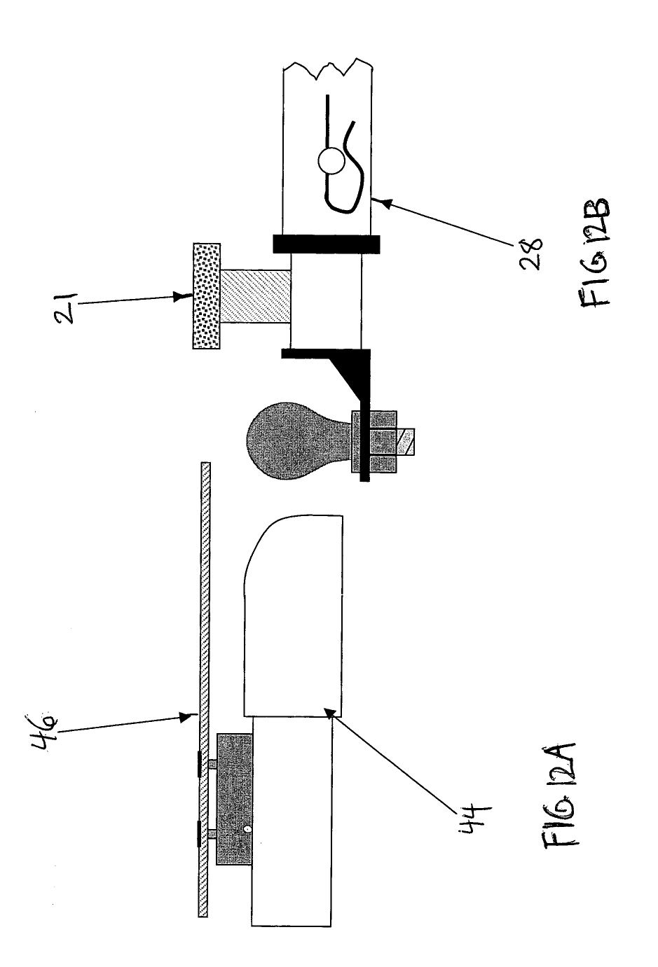

FIG. 11A is a top view of a pickup truck/SUV embodiment of the 5th wheel encoder 21 and a sensing wheel 22 coated with an elastomer or other material that provide sufficient frictional force to rotate the encoder mechanism when it is in contact with the trailer 3 and senses the relative angular positioning. These materials include magnetic wheels, elastomer to elastomer wheels, toothed (or geared) wheels, knurled wheels, and the like.

FIG. 11B is a side view of the ball hitch attachment point and the 5th wheel encoder assembly. In one embodiment, the space between the end of the ball hitch 24 and the receiver 28 is between about 2 and 3″.

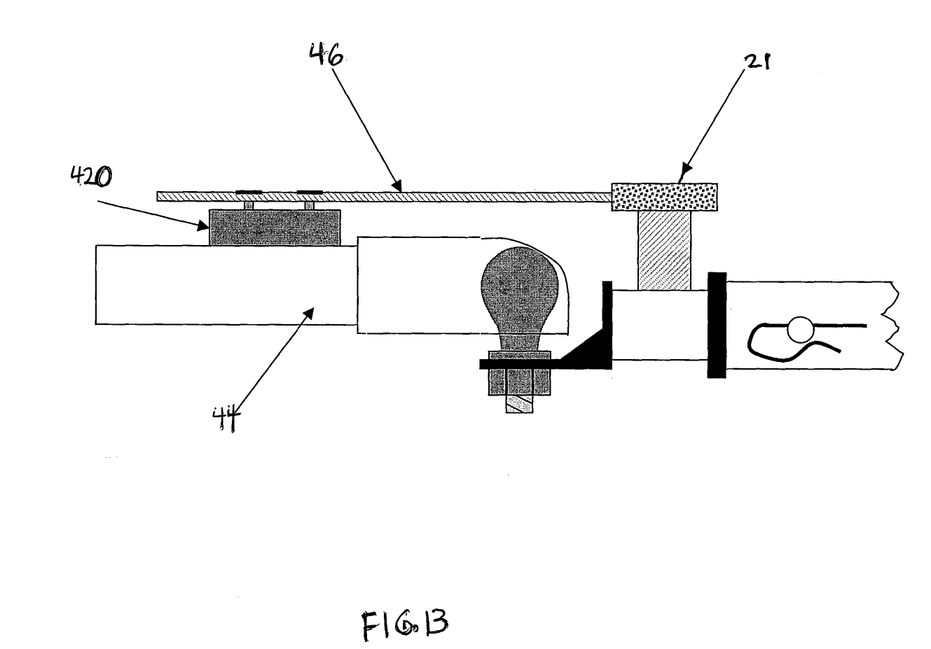

FIG. 12A shows a trailer hitch 44 with a magnetically attached contact plate for contacting the towing vehicle. It provides a fixed concentric surface whose center point is lined up with the center point of the ball of the ball hitch 24. The hitch may have a lip where magnetic material will be placed in order to line up with the magnetic material in the strike plate 42 of the 5th wheel encoder 21.

The strike plate 42 may have one of many standard sizes, such as 1⅞″ 2″, 2¼″, 2½″, etc. FIG. 20 shows the use of an SUV/pickup truck type ball hitch encoder 21 having a strike plate 42. The trailer hitch 44 fits into the slot of strike plate 42 and the magnetic attraction between the two metallic materials helps to secure them together. The center points of the trailer hitch 44 and strike plate 42 are aligned. The strike plate may be made out of injection-molded plastic with a magnetic backing. The inside of the slot of the strike plate 42 can be smooth, toothed, or knurled to fit complementary with trailer hitch 44.

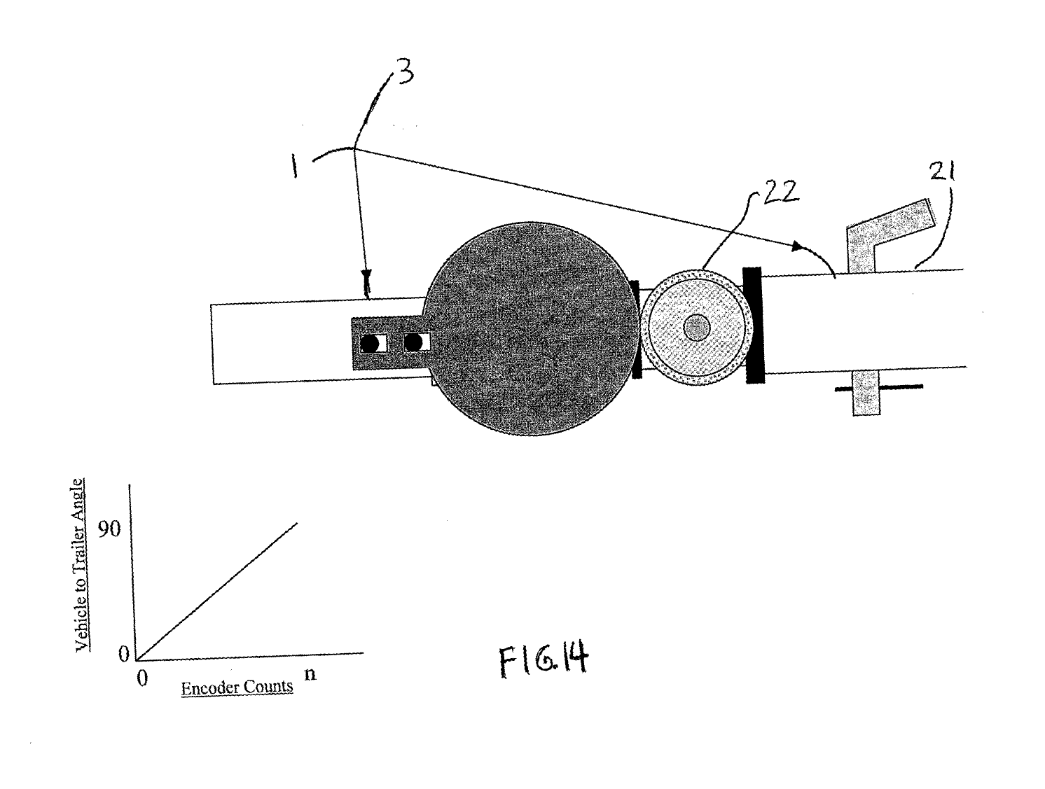

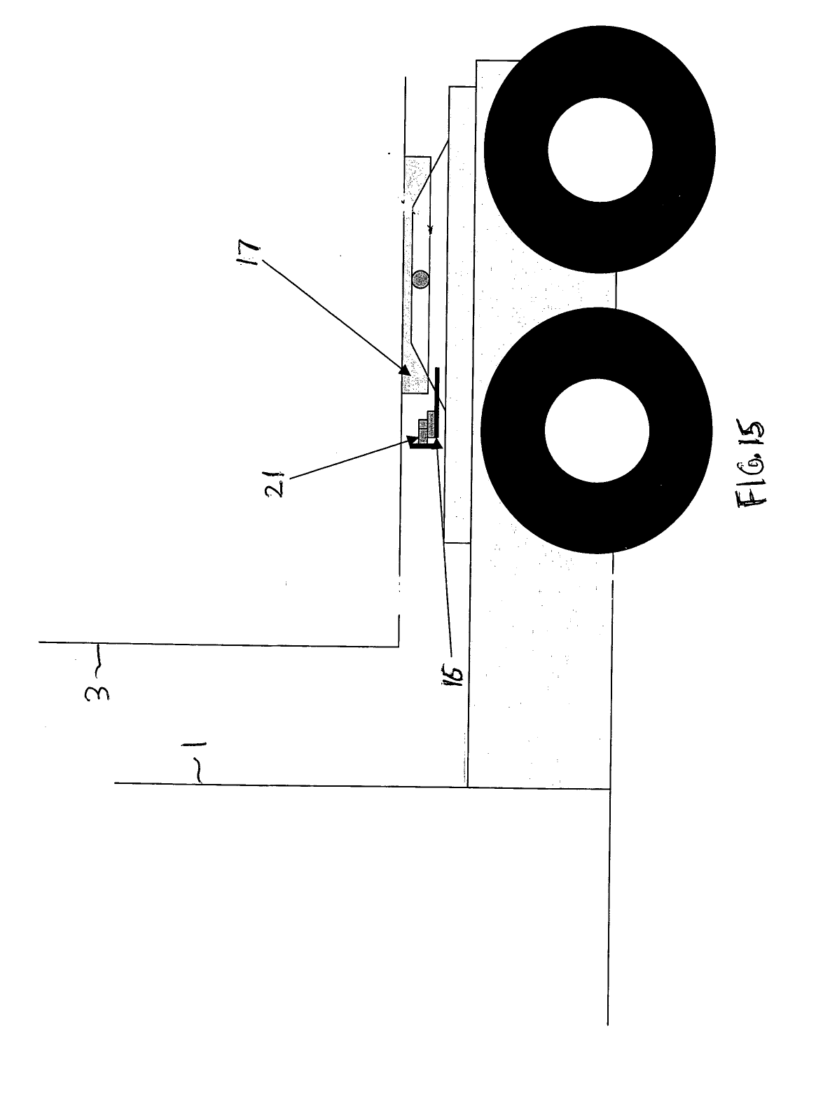

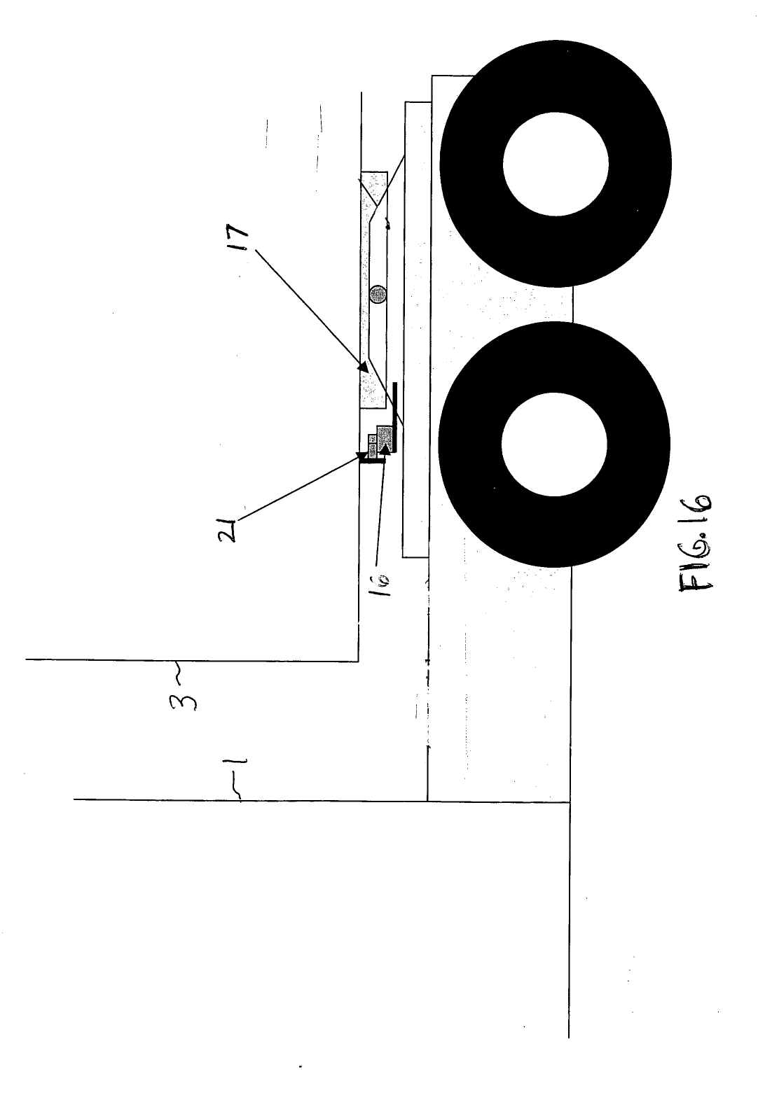

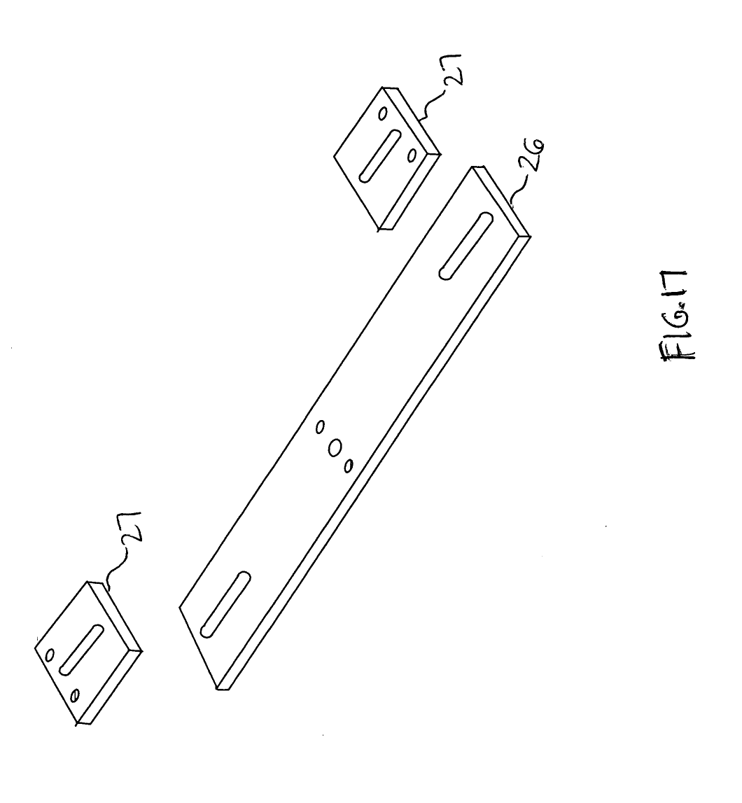

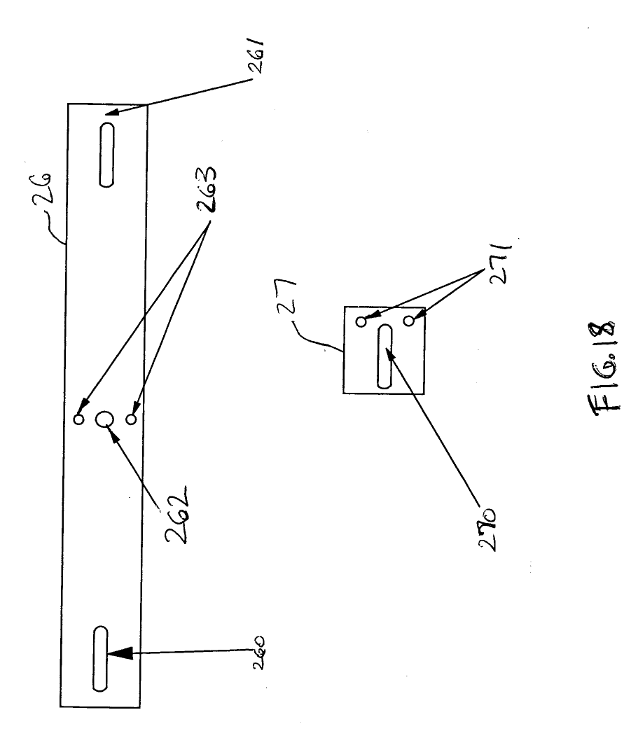

FIG. 12B shows a ball hitch with the 5th wheel encoder 21 and assembly. FIG. 13 shows the towed item attached to the pickup truck/SUV towing vehicle via the hitch engaging the ball hitch, and the magnetic contact base 420 in magnetic contact with the 5th wheel encoder 21.

FIG. 14 shows a top view of the 5th wheel encoder 21 engaged with a trailer 3. The graphs shows the linear relationship between the vehicle to trailer angle and the counts (rotation of the sensing wheel 22 or other movement) of the 5th wheel encoder 21.

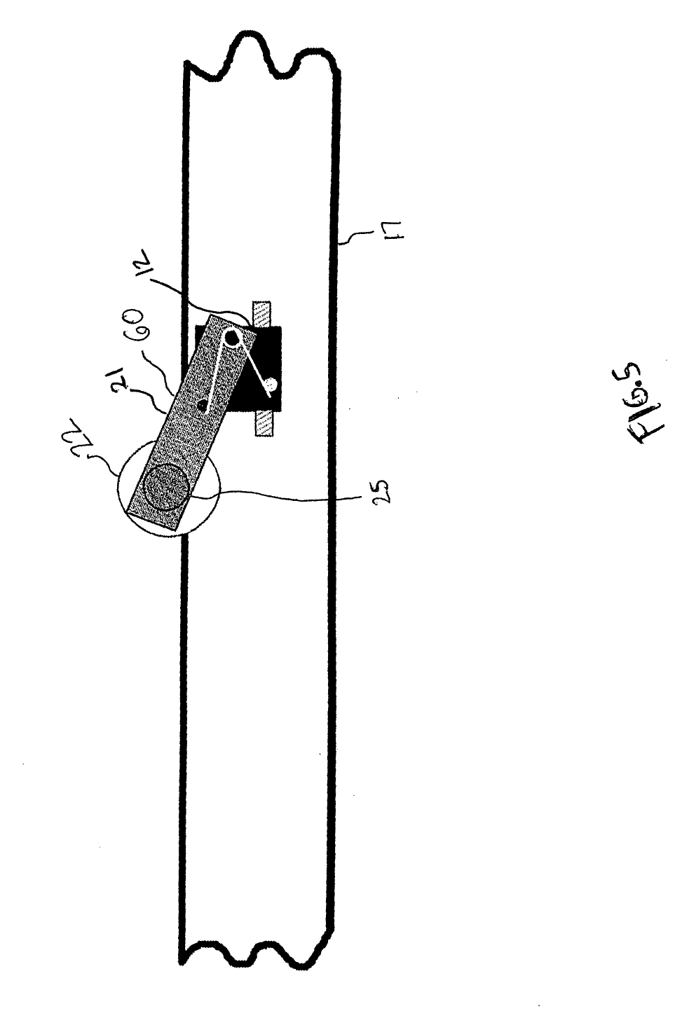

FIG. 5 shows one embodiment of the fifth wheel encoder 21 according to the present invention. The fifth wheel encoder 21 is attached to a towing vehicle 1 at the fifth wheel plate 17 or other attachment point 25 between the towing vehicle 1 and towed item 3. A sensing wheel 22 linked to a conventional spring rotates based on the relative positioning of the towing vehicle 1 and towed item 3. Optical encoder 60 transmits this information to microprocessor 12 that actuates the mirror(s) and/provides notification of positioning, for example, an audible signal to the driver of the towing vehicle, as described above.

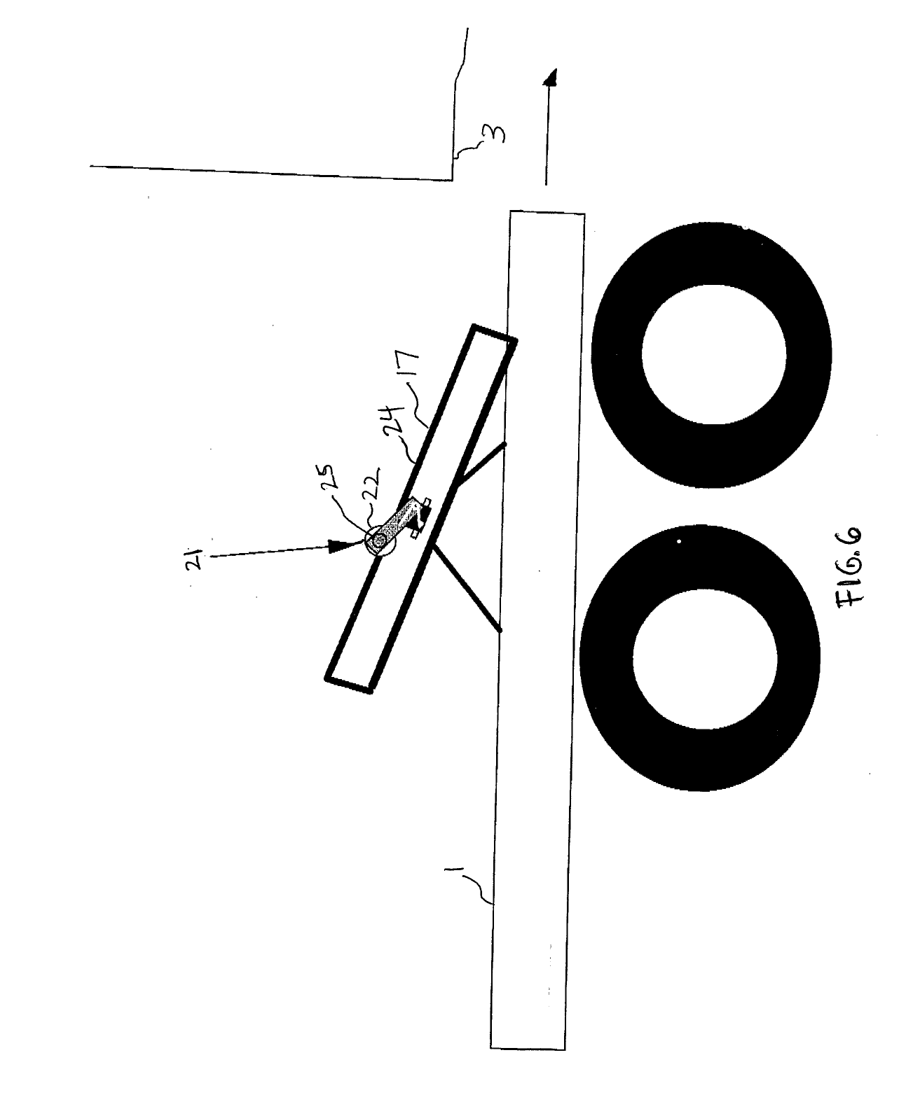

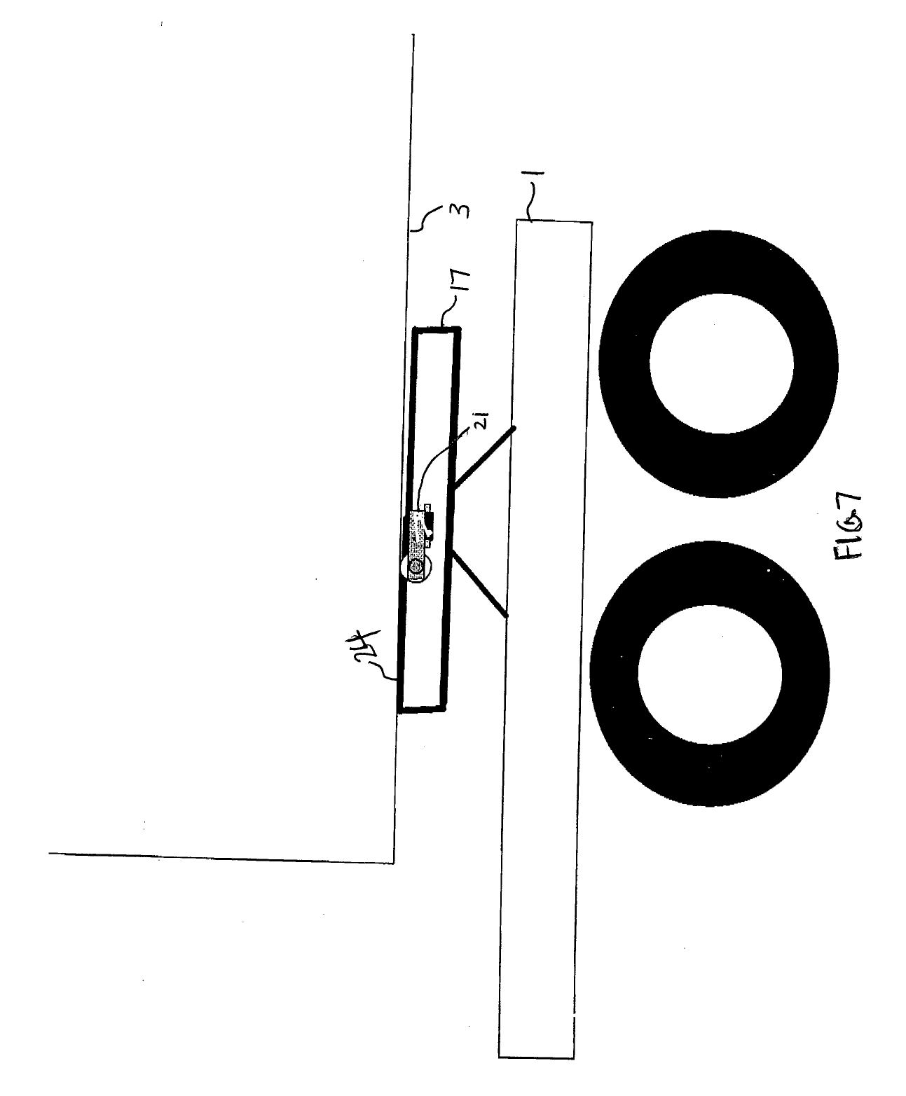

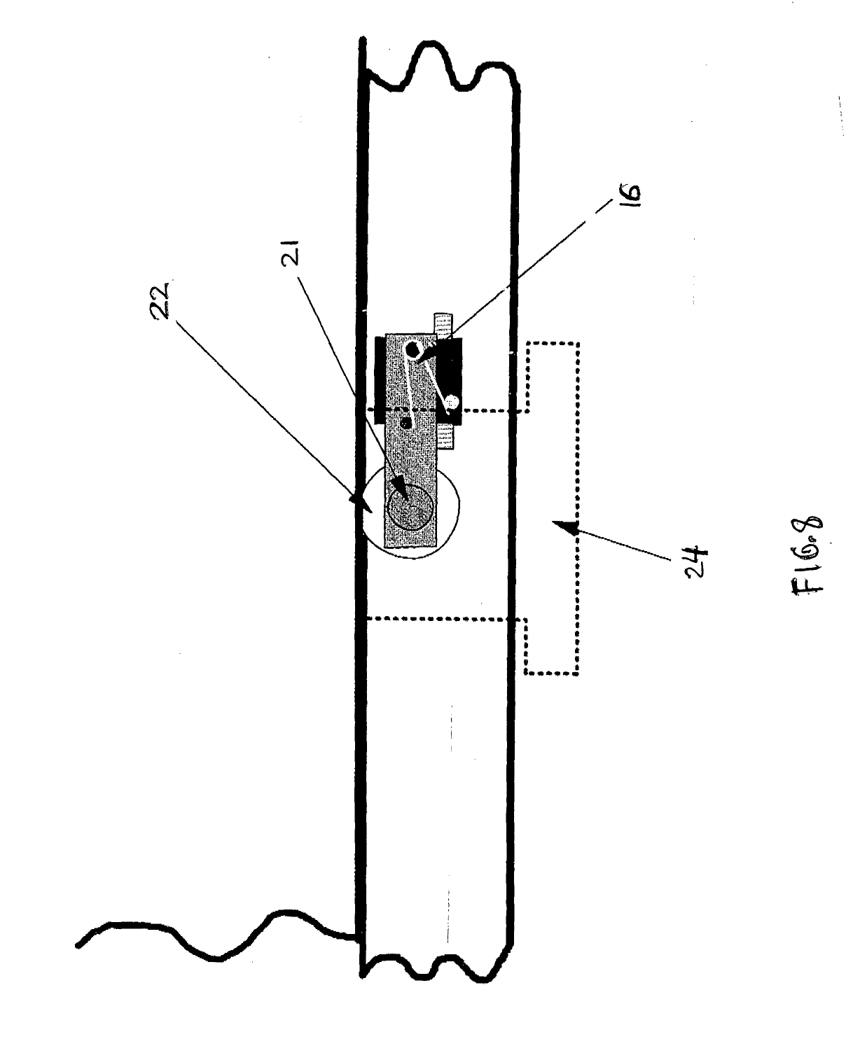

FIG. 6 shows the fifth wheel encoder 21 attached to the towing vehicle 1 at the kingpin 24 of the towing vehicle 1 where the trailer 3 would be attached. FIG. 7 shows the bottom of trailer 3 attached to the towing vehicle 1 through the 5th wheel encoder 21 that sits on the kingpin 24. FIG. 8 shows the tractor kingpin 24 and 5th wheel plate attachment point 17 to which the 5th wheel encoder 21 is attached. The sensing wheel 22 rotates and the spring mechanism 16 compresses and expands in response to the relative positioning of the tractor 1 and trailer 3. This allows the proper signal to be sent to the system to actuate the mirror(s) and/or provide notification or other safety features, as described above.

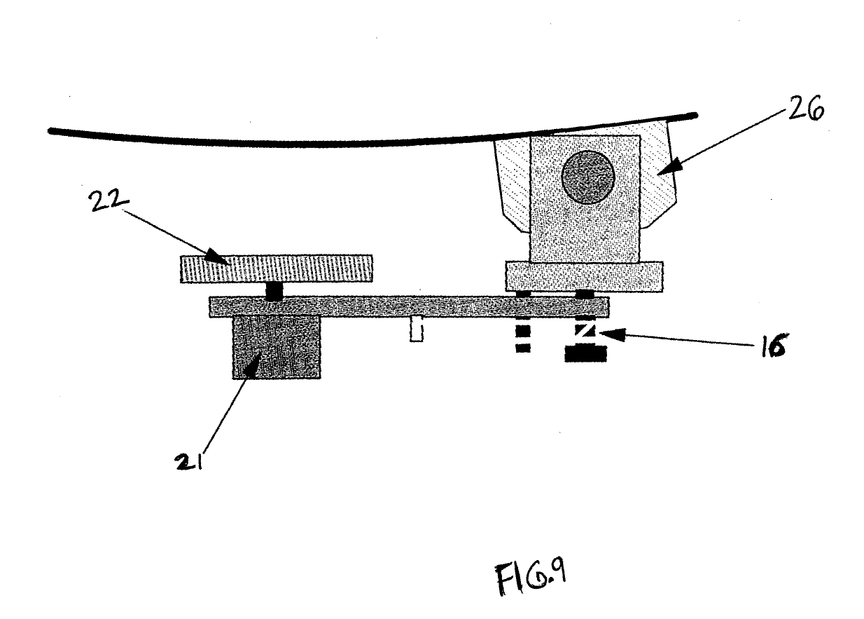

FIG. 9 is a top view of the invention, showing the fifth wheel plate 17 of a tractor 1 to which is attached the 5th wheel encoder 21. A mounting flange 26 attached to the fifth wheel plate 17 sits substantially horizontal such that the sensing wheel 22 of the 5th wheel encoder 21 rotates in a substantially vertical plane. The 5th wheel encoder 21 is fastened to the mounting flange 26 through known connection mechanism, such as screws, bolts, etc.

FIGS. 15 and 16 show use of an airspring as part of the 5th wheel encoder 21, both deflated and inflated. When inflated, the airspring makes tangential contact with the trailer.

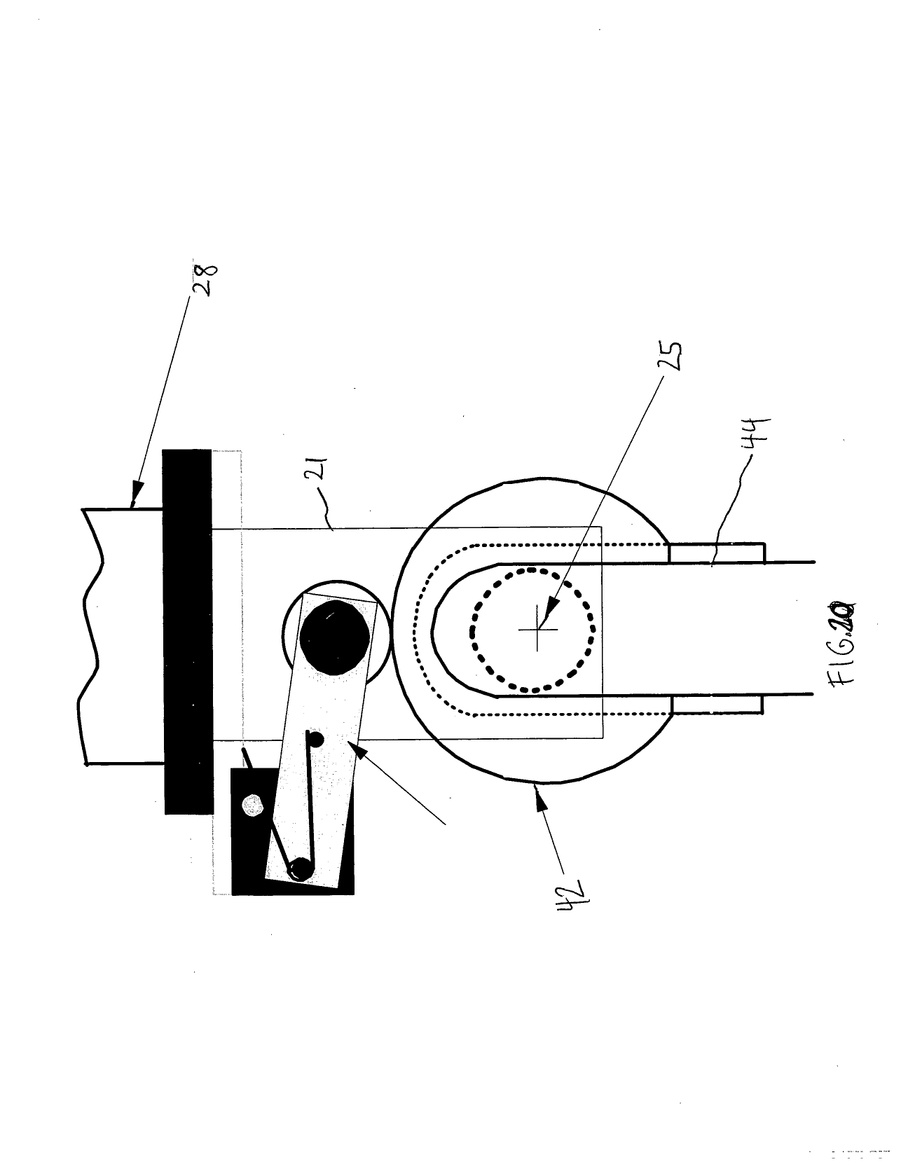

As shown in FIGS. 17-19, there are various mounting pieces (flanges) 26 for securing the 5th wheel encoder 21 and accompanying mechanism to the towing vehicle 1. The 5th wheel encoder 21 may be attached via a straight flange (FIG. 17), L-shaped (FIG. 19), or any other attachment mechanism, optionally with brackets 27, that will allow the sensing wheel 22 to stably rotate in response to the relative position of the towing vehicle 1 and towed item 3. The brackets may be made of metals, such as aluminum, steel, and their alloys, or any other material suitable for attachment and supporting the 5th wheel encoder 21.

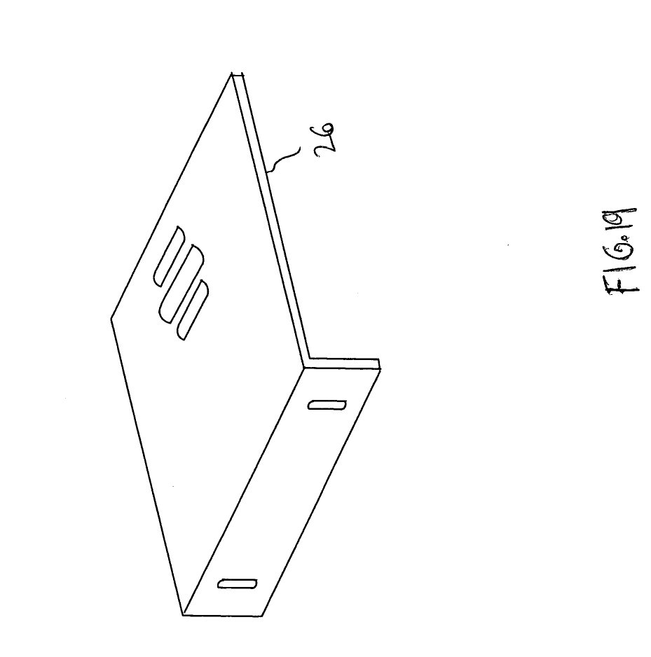

As shown in FIG. 18, flange 26 may be 20″ long and 3″ wide. It may have elongated slits 260 that are 7/16″×3½″ or slits 261 that are 12″ in depth. Also, flange 26 may have center circular hole 262 that is 9/16″ in diameter and holes 263 that are 7/16″ in diameter. In addition, bracket 27 may be 4″×3″ with elongated slit 270 that is 7/16″×3½″ and circular holes 271 that are 7/16″ in diameter. FIG. 19 shows a side mount flange 26 with a main piece that may be 8″×7″. These measurements are merely exemplary and other sizes and shapes for the flange 26, bracket 27, and various openings may be used.

FIGS. 21-24 show flow charts of the steps of the computer software used in connection with the 5th wheel encoder of the present invention.

While illustrated and described above with reference to certain specific embodiments, the present invention is nevertheless not intended to be limited to the details shown. Rather, the present invention is directed to a computer controlled positioning device for a towed item and method of use, and various modifications may be made in the details within the scope and range of equivalents of the description and without departing from the spirit of the invention.

What is claimed is:

1. A positioning apparatus for a towing vehicle having an attachment point comprising:
a towing vehicle having an attachment point for attaching a towed item;
a 5th wheel encoder secured to the attachment point, the 5th wheel encoder adapted to be in contact with the towed item;
a sensor on the 5th wheel encoder for determining an angular position of the towed vehicle relative to the towed item; and
a device for receiving the relative angular position and transmitting information on the relative angular position.

2. The positioning apparatus of claim 1, wherein the towing vehicle comprises a rearview mirror and further comprising a device for actuating the position of the rearview mirror based on the information on the relative angular position.

3. The positioning apparatus of claim 2, wherein the position of the mirror is actuated by a geared stepper motor.

4. The positioning apparatus of claim 3, wherein the receiving device is a microprocessor for correlating the position of the rearview mirror to the relative angular position.

5. The positioning apparatus of claim 1, further comprising a device for notification of the relative angular position.

6. The positioning apparatus of claim 1, wherein the 5th wheel encoder comprises a rotating device, the rotating device being adapted to sense the relative angular position and to rotate in a direction and an amount correlated to the relative angular position.

7. The positioning apparatus of claim 6, wherein the rotating device is an actuating wheel mechanically coupled to an optical encoder, the optical encoder being adapted to detect and transmit to the receiving device the direction and amount of rotation of the actuating wheel.

8. The positioning apparatus of claim 7, further comprising a microprocessor to receive the direction and amount of rotation, determine the relative angular position, and transmit at least one of a signal to actuate a rearview mirror of the towing vehicle and a signal to provide notification of the relative angular position, wherein the microprocessor comprises software for controlling the receipt, determination, and transmission.

9. The positioning apparatus of claim 8, wherein the notification provided is a visible or audible warning to a driver of the towing vehicle.

10. The positioning apparatus of claim 8, wherein the software is programmable.

11. The positioning apparatus of claim 10, wherein the software comprises a mathematical equation for correlating the direction and the amount of rotation of the actuating wheel to the relative angular position.

12. The positioning apparatus of claim 11 wherein the mathematical equation maintains a constant proportionality ratio between the relative angular position and the positioning of a rearview mirror.

13. The positioning apparatus of claim 8 wherein the software uses routines or look up tables to correlate the relative angular position with the actuation of the rearview mirror.

14. The positioning apparatus of claim 6, wherein the 5th wheel encoder comprises at least one of a conventional spring mechanism, an air spring utilizing compressed air, and a solenoid utilizing electrical current for maintaining a constant force between the rotating device and the towed item.

15. The positioning apparatus of claim 1, further comprising a display for showing the relative angular position.

16. The positioning apparatus of claim 1, wherein the attachment point is selected from the group consisting of a fifth wheel plate, a ball and hitch mechanism, and a pintle hitch.

17. The positioning apparatus of claim 1, wherein the 5th wheel encoder is secured to the attachment point by a mounting flange.

18. The positioning apparatus of claim 17, wherein the mounting flange is substantially planar or L-shaped.

19. The positioning apparatus of claim 1, further comprising a towed item attached to the towing vehicle at the attachment point, wherein the 5th wheel encoder comprises a rotating device in contact with the towed item.

20. The positioning apparatus of claim 19, wherein the rotating device is coupled to an optical encoder, the optical encoder being adapted to detect and transmit to the receiving device the direction and amount of rotation of the rotating device.

21. A positioning apparatus for a towing vehicle having a fifth wheel plate attachment point comprising:
a towing vehicle having a fifth wheel plate;
a towed item attached to the towing vehicle at the fifth wheel plate;
a 5th wheel encoder secured to the attachment point, the 5th wheel encoder comprising an actuating wheel being in contact with the towed item for determining an angular position of the towed vehicle relative to the towed item, the actuating wheel mechanically coupled to an optical encoder; and
a microprocessor device for receiving the relative angular position from the optical encoder and transmitting information on the relative angular position to a rearview mirror actuating device for controlling the position of a rearview mirror and to a notification device for providing notification of the relative angular positioning.

22. A computer-readable medium with executable instructions for performing the steps of:
receiving a signal from a sensor, the signal comprising positional variables selected from the group consisting of the relative angular position of a towing vehicle and a towed item, a position of a rearview mirror, a distance from the rearview mirror and an attachment point, and a distance from the attachment point to an axle of a trailer; and
correlating the positional variables using at least one of routines and lookup tables.

23. The computer-readable medium of claim 22, further comprising performing the step of displaying the relative angular position in degrees or radians.
